(19) United States
(12) Patent Application Publication
(10) Pub. No.: US 2025/0322284 A1
(43) Pub. Date: Oct. 16, 2025

(54) NON-TRANSITORY COMPUTER-READABLE RECORDING MEDIUM, CALCULATION METHOD AND INFORMATION PROCESSING DEVICE

(71) Applicant: Fujitsu Limited, Kawasaki-shi (JP)

(72) Inventors: Akito MARUO, Atsugi (JP); Hideyuki JIPPO, Atsugi (JP); Takeshi SOEDA, Kawasaki (JP)

(73) Assignee: Fujitsu Limited, Kawasaki-shi (JP)

(21) Appl. No.: 19/248,702

(22) Filed: Jun. 25, 2025

Related U.S. Application Data
(63) Continuation of application No. PCT/JP2024/001892, filed on Jan. 23, 2024.

(30) Foreign Application Priority Data
Feb. 28, 2023 (JP) 2023-029896

(51) Int. Cl. G06N 10/60

(52) U.S. Cl. CPC G06N 10/60

(57) ABSTRACT

A calculation program causes a computer to execute a process including determining a first set number and a second set number according to accuracy of an Ising model, in repeating of a process of creating the Ising model based on a learning data group, searching for the first set number of a first recommendation point for the Ising model using an Ising machine, searching for the second set number of a second recommendation point for a learning data by a genetic algorithm, and adding the first recommendation point and a first evaluation value of the first recommendation point, and the second recommendation point and a second evaluation value of the second recommendation point, respectively, to the learning data group as a learning data.

### CROSS-REFERENCE TO RELATED APPLICATION

This application is a continuation application of PCT/JP2024/001892, filed on Jan. 23, 2024, which is based upon and claims the benefit of priority of the prior Japanese Patent Application No. 2023-029896, filed on Feb. 28, 2023, the entire contents of which are incorporated herein by reference.

### FIELD

A certain aspect of embodiments described herein relates to a non-transitory computer-readable recording medium, a calculation method and an information processing device.

### BACKGROUND ART

Technologies have been disclosed that perform optimization by sampling binary variables (see, for example, Japanese Patent Application Publication No. 2022-190752, Japanese Patent Application Publication No. 2021-33544 and Japanese Patent Application Publication No. 2022-45870).

### SUMMARY

In one aspect, there is provided a non-transitory computer-readable recording medium that stores a program causing a computer to execute a process, the process including: determining a first set number and a second set number according to accuracy of an Ising model, in repeating of a process of creating the Ising model based on a learning data group, searching for the first set number of a first recommendation point for the Ising model using an Ising machine, searching for the second set number of a second recommendation point for a learning data by a genetic algorithm, and adding the first recommendation point and a first evaluation value of the first recommendation point, and the second recommendation point and a second evaluation value of the second recommendation point, respectively, to the learning data group as a learning data.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating a solution search in a QUBO format.

FIG. 2 is a diagram illustrating evaluation values of movies watched by many users.

FIG. 3 is a flowchart of an execution procedure of a sampling technique using a QUBO format model.

FIG. 4A is a block diagram illustrating an overall configuration of an information processing device, and FIG. 4B is a block diagram illustrating a hardware configuration of an information processing device.

FIG. 5 is a flowchart of an example of an operation of an information processing device.

FIG. 6A is a diagram illustrating crossover, and FIG. 6B is a diagram illustrating mutation.

FIG. 7A is a diagram illustrating an optimization problem for a magnetic shield, FIG. 7B is a diagram illustrating an arrangement of Gaussian basis functions, and FIG. 7C is a diagram illustrating magnetic flux lines generated from a coil.

FIG. 8 is a diagram illustrating positive and negative arrangements.

FIG. 9 is a diagram of distribution of a shape function y.

FIG. 10A and FIG. 10B are figures of simulation results.

FIG. 11A and FIG. 11B are figures of simulation results.

FIG. 12A to FIG. 12C are lists of results obtained by each search using a random sampling method, an FMDA-only method, and a method of this embodiment.

FIG. 13A is a graph of a number of DA recommendations and a number of GA recommendations in each iteration, and FIG. 13B is a graph of a plot of best value in each iteration.

### DESCRIPTION OF EMBODIMENTS

For example, sampling technology using a QUBO-format Ising model is a method for sequentially sampling recommendation points on the model, which may limit the sampling area. Therefore, it is possible to use multiple recommendation methods. However, when multiple recommendation methods are used, it is difficult to adjust the number of recommendations. As a result, there is a risk that the number of samplings may become too many.

Binary variable sampling technology is used as a technique for searching for a good solution with a high evaluation value from a large number of combinations and sequences. Examples of binary variable sampling technology are such as random sampling technology, sampling technology using a QUBO format Ising model and so on.

Random sampling technology allows easy sampling, but has the disadvantage that sampling efficiency is poor and a large number of samplings are required to obtain a good solution with high accuracy.

An example of a sampling technology using a QUBO format model is FMQA (Factorization Machine with Quantum Annealing) or the like. FMQA is a method that combines QA (quantum annealing) and FM (machine learning method). FMQA creates a QUBO format FM model from training data, finds a good solution through QA, analyzes the evaluation value of the good solution with a solver, adds the result to the training data, and performs sampling interactively. Another sampling technique using a QUBO model is the FMDA technique. FMDA replaces the QA part of FMQA with DA (Digital Annealer).

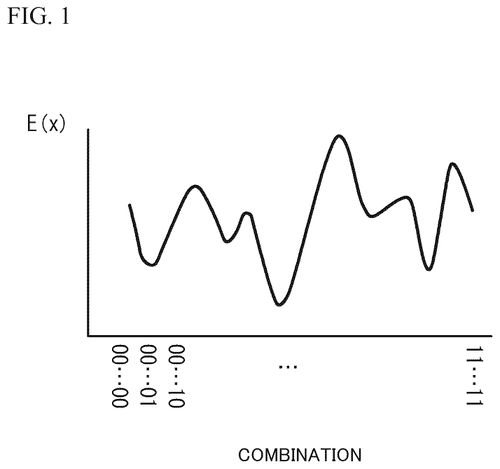

Here, the QUBO format stands for Quadratic Unconstrained Binary Optimization, which is a format that allows binary optimization without quadratic constraints. The QUBO format can be expressed, for example, as in the following equation. Note that xᵢ=0 or 1 (i=1, . . . , N). Wᵢⱼ is the coupling coefficient between xᵢ and xⱼ. bᵢ is the bias coefficient of xᵢ. The first term on the right side is a quadratic term and represents the interaction. The second term on the right side is a linear term and represents the bias action. The third term on the right side is a constant term. In the QUBO format, a good solution x for minimizing E(x), which represents energy, is searched for according to the following equation, as illustrated in FIG. 1.

$$E ( x ) = - {\sum }_{i , j} {W}_{ij} {x}_{i} {x}_{j} - {\sum }_{i} {b}_{i} {x}_{i} + const . \qquad [ Equation 1 ]$$

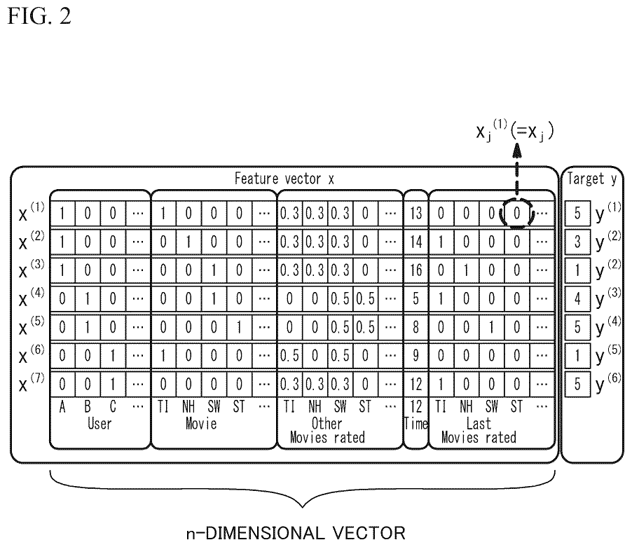

Here, we will explain the outline of FMDA as an example of a sampling technique using a QUBO format model. FIG. 2 illustrates the evaluation values of movies watched by many users. These evaluation values are in the form of n-dimensional vectors. First, a QUBO format model to represent interactions is created from these evaluation values. The QUBO format model can be expressed as the following equation.

$$\hat{y} ( {x}^{( k )} ) := {w}_{0} + {\sum }_{i = 1}^{n} {w}_{i} {x}_{i}^{( k )} + {\sum }_{i = 1}^{n} {\sum }_{j = i + 1}^{n} 〈 {v}_{i} , {v}_{j} 〉 {x}_{i}^{( k )} {x}_{j}^{( k )} \qquad [ Equation 2 ]$$

In the above equation, w₀, wᵢ, vᵢ, and vⱼ are coefficients to be learned. This machine learning model is a model that is strong against sparse data sets. Since this model is in the QUBO format, a QUBO format model can be automatically generated by learning FM.

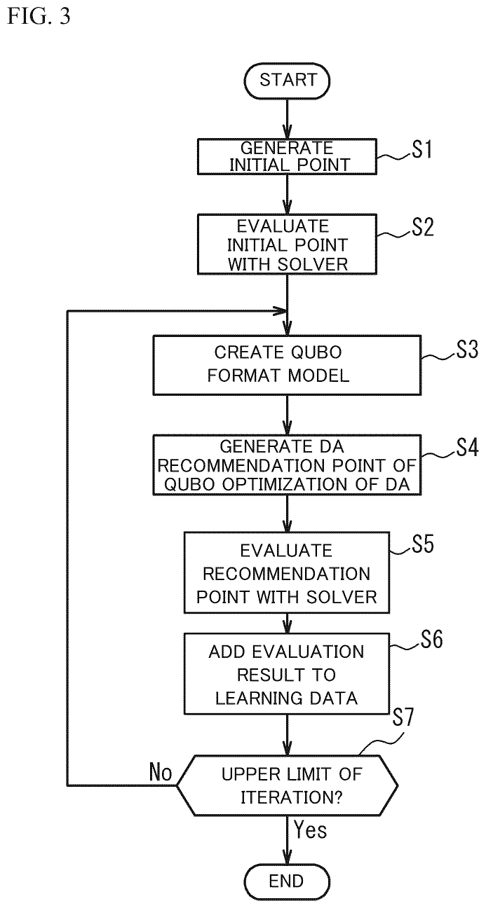

FIG. 3 is a flowchart of the execution procedure of a sampling technique using a QUBO format model. As illustrated in FIG. 3, first, a group of learning data is generated by randomly generating learning data (initial points) (step S1). The number of learning data to be generated is determined by the user's settings.

Next, a solver is used to calculate the evaluation values of the initial points (step S2). The evaluation value is an index for judging whether the initial point and the recommendation point described later are good or not. Through the above steps, an initial learning data group consisting of a set of the initial point and the evaluation value is generated.

Next, a QUBO format model is created by generating an FM from the learning data group (step S3). Since the FM is in the QUBO format, generating an FM is equivalent to generating a QUBO format model. Other machine learning models can be used as long as they can generate a QUBO format model.

Next, DA is used to optimize the created QUBO format model, and a good solution (DA recommendation point) with the best evaluation value is generated (step S4).

Next, a solver is used to calculate the evaluation value of the DA recommendation point (step S5).

Next, the evaluation result (a set of recommendation point and evaluation value) is added to the learning data group as learning data (step S6).

Next, it is determined whether the number of iterations has reached the upper limit (step S7). If the result of the determination in step S7 is “No”, the process is executed again from step S3. As a result, steps S3 to S6 are repeated until the termination condition is met. If the result of the determination in step S7 is “Yes”, the execution of the flowchart ends. Note that, as the termination condition, a condition such as a case where the change in the objective function is less than a threshold value for a certain period of time can be used.

The above procedure updates the learning data group, and an optimal solution can be obtained.

Note that, although FMDA is described in FIG. 3, the DA part of FMDA may be replaced with QA, and other methods may be used as long as the Ising machine can solve QUBO.

The sampling technique using the QUBO format model is a method of sequentially sampling the recommendation points on the model, so there is a risk that the sampling area may be limited. Furthermore, in sampling techniques using QUBO format models, sampling performance depends on the set of training data used to generate the model. Also, because FM is a second-order model, there is a possibility that it may not be able to fully express the problem. Also, when using multiple recommendation methods, it is difficult to adjust the number of recommendations. For these reasons, in order to increase the accuracy of the search for the optimal solution, the number of samplings becomes large.

Therefore, in the following embodiment, an example in which the number of samplings can be reduced is described.

### First Embodiment

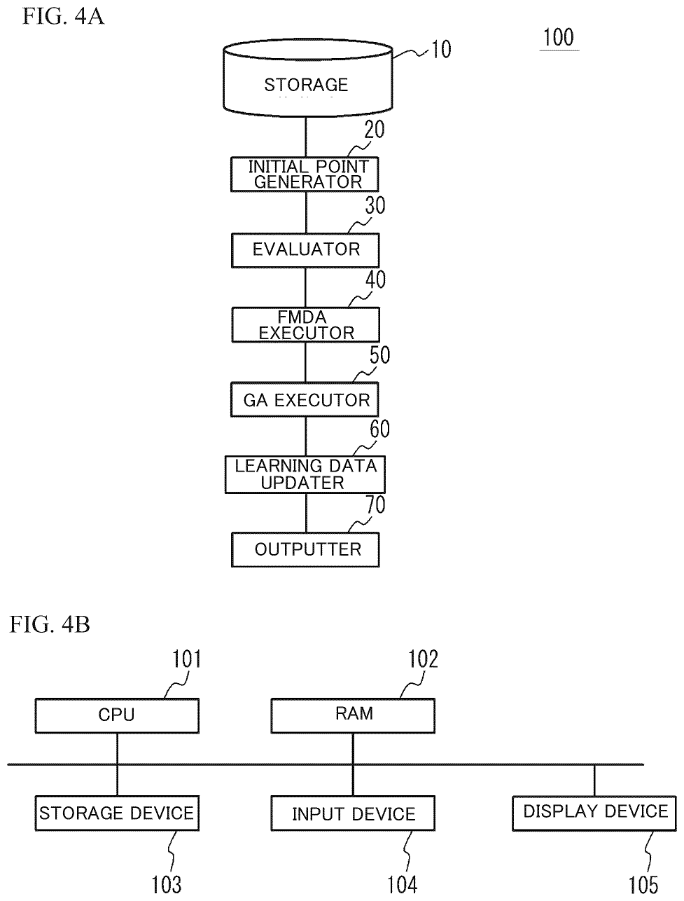

FIG. 4A is a block diagram illustrating an example of the overall configuration of an information processing device 100. As illustrated in FIG. 4A, the information processing device 100 includes a storage 10, an initial point generator 20, an evaluator 30, an FMDA executor 40, a GA executor 50, a learning data updater 60, an outputter 70, and the like.

FIG. 4B is a block diagram illustrating an example of the hardware configuration of the information processing device 100. As illustrated in FIG. 4B, the information processing device 100 includes a CPU 101, a RAM 102, a storage device 103, an input device 104, a display device 105, and the like.

The CPU (Central Processing Unit) 101 is a central processing unit. The CPU 101 includes one or more cores. The RAM (Random Access Memory) 102 is a volatile memory that temporarily stores the program executed by the CPU 101, the data processed by the CPU 101, and the like. The storage device 103 is a non-volatile storage device. For example, a ROM (Read Only Memory), a solid state drive (SSD) such as a flash memory, or a hard disk driven by a hard disk drive can be used as the storage device 103. The storage device 103 stores a calculation program. The input device 104 is an input device such as a keyboard or a mouse. The display device 105 is a display device such as an LCD (Liquid Crystal Display). When the CPU 101 executes the calculation program, the storage 10, the initial point generator 20, the evaluator 30, the FMDA executor 40, the GA executor 50, the learning data updater 60, the outputter 70, and the like are realized. In addition, hardware such as dedicated circuits may be used as the storage 10, the initial point generator 20, the evaluator 30, the FMDA executor 40, the GA executor 50, the learning data updater 60, the outputter 70, and the like.

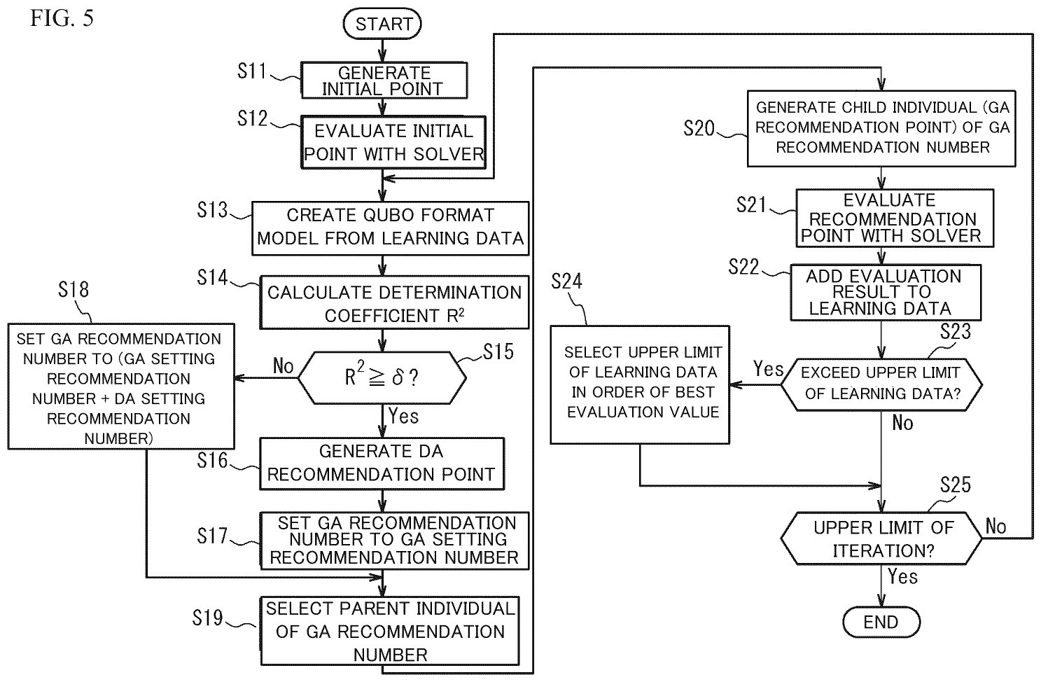

FIG. 5 is a flowchart of an example of the operation of the information processing device 100. As illustrated in FIG. 5, the initial point generator 20 generates a learning data group by randomly generating learning data (initial points) (step S11). The number of learning data to be generated is determined by the user's settings.

Next, the evaluator 30 uses a solver to calculate the evaluation values of the initial points (step S12). The initial learning data group, which is a set of the initial point obtained in step S11 and the evaluation value calculated in step S12, is stored in the storage 10.

Next, the FMDA executor 40 generates a model in the QUBO format by generating an FM from the training data group stored in the storage 10 (step S13). Since the FM is in the QUBO format, generating an FM is equivalent to generating a model in the QUBO format. Other machine learning models can be used as long as they can generate a model in the QUBO format.

Next, the FMDA executor 40 calculates the coefficient of determination R2 for the training data group of the FM model (step S14). The coefficient of determination R2 is an index of model accuracy, and the closer it is to 1, the better the accuracy of searching for a good solution with a high evaluation value. The coefficient of determination R2 can be calculated, for example, by the following equation.

$${R}^{2} = 1 - \frac{{\sum }_{i = 1}^{n} ( {y}_{i} - \hat{y} )}{{\sum }_{i = 1}^{n} {( {y}_{i} - \overline{y} )}^{2}} \qquad [ Equation 3 ]$$

In the equation, yᵢ is the actual measurement value. The equation below is the predicted value.

$$\hat{y} \qquad [ Equation 4 ]$$

The equation below is the average value of the actual measurement values.

$$\overline{y} \qquad [ Equation 5 ]$$

Next, the FMDA executor 40 judges whether the coefficient of determination R2 is equal to or greater than a threshold value δ (step S15). The threshold value δ is preset by the user. Here, an example of the threshold value δ will be described. For example, when step S15 is executed for the first time, the threshold value δ is set to about 0.8. It is preferable to reduce the value of the threshold value δ when the DA recommendation is working effectively, and to increase the value of the threshold value δ when the DA recommendation is not working effectively. For example, whether the DA recommendation is working effectively can be judged by whether the ratio of the results judged as “Yes” in step S15 is equal to or greater than a threshold value.

If the result in step S15 is “Yes”, the FMDA executor 40 generates DA recommendation points by QUBO optimization by DA for the number of DA setting recommendations (step S16). The number of DA setting recommendations is preset by the user. The DA recommendation points are the good solutions (recommendation points) that have the best evaluation value. Alternatively, the DA recommendation point is a good solution (recommendation point) whose evaluation value is equal to or greater than a threshold value. Alternatively, the DA recommendation point is a good solution (recommendation point) whose evaluation value is within a predetermined top ranking.

Then, the GA executor 50 sets the GA recommendation number to the GA setting recommendation number (step S17).

If the result of step S15 is “No”, the GA executor 50 sets the GA recommendation number to (GA setting recommendation number+DA setting recommendation number) (step S18). The GA setting recommendation number is preset by the user. The GA recommendation number does not have to be (GA setting recommendation number+DA setting recommendation number), but may be a number that is greater than the GA recommendation number.

After execution of step S16 or step S18, the GA executor 50 selects parent individuals equal to the number of GA recommendations from the learning data group stored in the storage 10 (step S19). The method of selecting parent individuals is not particularly limited, but may include a method of randomly extracting individuals (tournament size NT) that exceed the number of GA recommendations from the learning data group, and selecting individuals that are equal to the number of GA recommendations with high evaluations from among them (tournament selection). Alternatively, individuals equal to the number of GA recommendations with the highest evaluations may be selected from the learning data group (elite selection). The tournament size NT is preset by the user.

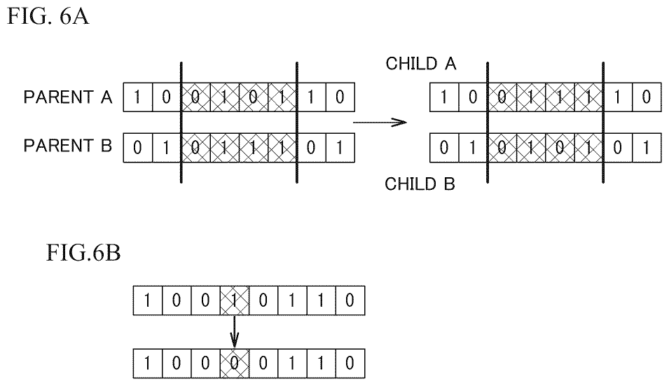

Then, the GA executor 50 generates the number of child individuals (GA recommendation points) to be recommended by the GA from the parent individuals by crossover and mutation (step S20). FIG. 6A is a diagram illustrating crossover. For example, some genes (crossover points) of parent individual A and some genes (crossover points) of parent individual B are randomly determined and swapped to generate child individuals A and B. FIG. 6B is a diagram illustrating mutation. For example, a randomly selected gene is replaced with an allele. The crossover probability and mutation probability are preset by the user.

Then, the evaluator 30 uses a solver to calculate the evaluation value of the recommendation points (step S21). The recommendation points here refer to the DA recommendation points and GA recommendation points if step S16 is executed, and refer to the GA recommendation points if step S18 is executed.

Next, the learning data updater 60 adds the evaluation result (a set of recommendation points and evaluation value) to the learning data group as learning data (step S22).

Next, the learning data updater 60 judges whether the number of learning data in the learning data group exceeds the upper limit (step S23). The upper limit of the number of learning data is preset by the user.

If the judgment in step S23 is “Yes”, the learning data updater 60 selects the upper limit of learning data in order of best evaluation value, and deletes the learning data other than the selected learning data (step S24). Alternatively, the learning data updater 60 may select learning data whose evaluation value is equal to or greater than a predetermined value, and delete the learning data other than the selected learning data.

If the judgment in step S23 is “No”, or after execution of step S24, the FMDA executor 40 judges whether the number of iterations has reached the upper limit (step S25). The number of times step S25 is executed may be the number of iterations. The upper limit of the number of iterations is preset by the user.

If the judgment in step S25 is “No”, execution is performed again from step S13. If the determination in step S25 is “Yes”, execution of the flowchart ends.

The outputter 70 outputs the results of the processing in FIG. 5. The output results are displayed, for example, by the display device 105. For example, the outputter 70 may output the contents of the learning data group, or may output learning data with a high evaluation value from the learning data group as a good solution.

According to this embodiment, the number of DA setting recommendations and the number of GA setting recommendations are determined according to the accuracy of the FM model generated from the learning data group. This makes it possible to achieve both high accuracy for obtaining a good solution and a reduction in the number of samplings.

For example, if the accuracy of the FM model generated from the learning data is low, there is a risk that the accuracy of searching for a good solution in DA will be low. Therefore, the number of GA recommendations is increased without DA recommendation. By using GA, the learning data can be taken as a group of individuals and recommendation points can be generated using GA processing. This makes it possible to sample a wide range of areas where the evaluation value is likely to improve. In this case, since DA recommendation is not performed with low accuracy, as a result, a good solution can be obtained with high accuracy with a small number of samplings.

For example, if the accuracy of the FM model generated from the learning data group is high, a good solution on the FM model can be generated as a recommendation point by DA. In this case, areas with high evaluation values can be actively sampled. This makes it possible to reduce the number of samplings required to obtain a good solution.

As described above, this embodiment can achieve both high accuracy for obtaining a good solution and a reduction in the number of sampling times.

Furthermore, when the number of data in the training data group exceeds the upper limit, the training data group is updated according to the evaluation value of each piece of training data contained in the training data group, thereby improving the accuracy of the modeling used for sampling.

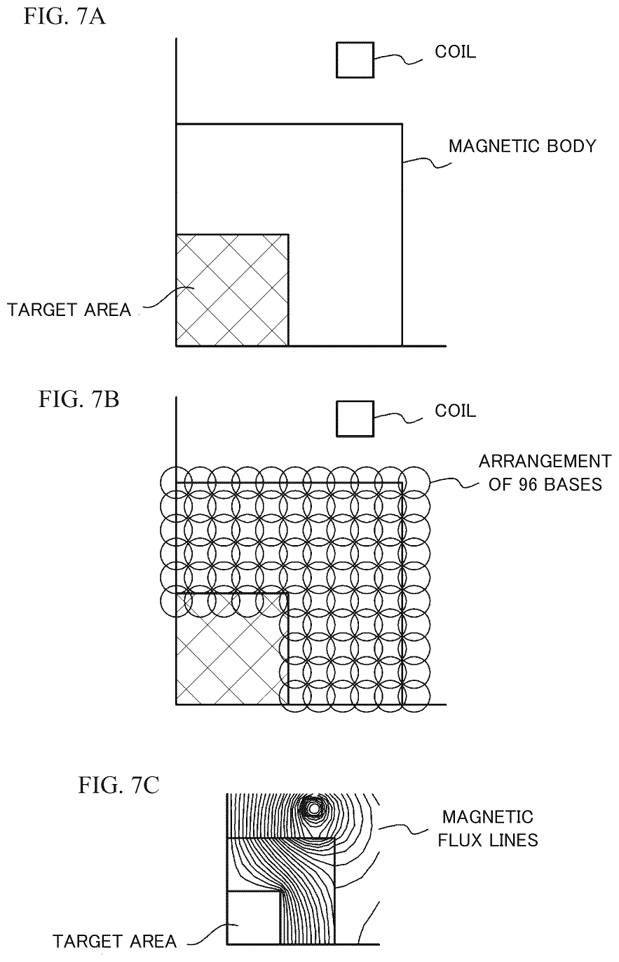

(Simulation Results) Below, we will explain the results of a simulation in which a hypothetical problem was set and the computational processing according to the above embodiment was performed. FIG. 7A is a diagram illustrating an optimization problem for a magnetic shield. FIG. 7A is a diagram illustrating a magnetic shield analysis model, and illustrates the coil, magnetic body design area, and target area. The target area is an area where it is desired to prevent the influence of magnetic flux. The magnetic body design area is an area for placing the magnetic body. FIG. 7B is a diagram illustrating the placement of Gaussian basis functions. As illustrated in FIG. 7B, 96 magnetic bodies can be placed in the magnetic body design area. FIG. 7C is a diagram illustrating the magnetic flux lines generated from the coil.

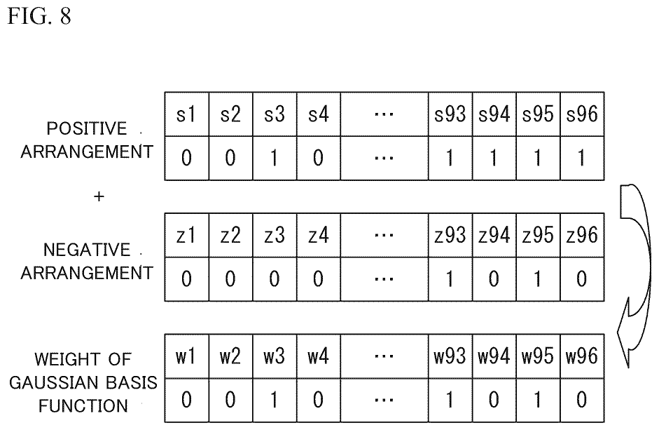

The table in FIG. 8 is a diagram illustrating positive placement and negative placement. s1 to s96 indicate 96 positive placement locations. In s1 to s96, “0” indicates that no magnetic body is placed, and “1” indicates that a magnetic body is placed. z1 to z96 indicate 96 negative placement locations. “0” in z1 to z96 indicates that no magnetic material is placed, and “1” indicates that a magnetic material is placed.

This placement problem can be expressed as the shape function y as expressed in the following equation. sᵢ,zᵢ∈{0,1}, and wᵢ∈{−1,0,1}. In this way, the optimization problem of the magnetic shield is viewed as a placement problem of positive and negative Gaussian basis functions.

$$y ( x , s , z ) = {\sum }_{i = 1}^{{N}_{G}} ( {s}_{i} - {z}_{i} ) \{ {G}_{i} ( x ) / {\sum }_{i = 1}^{{N}_{G}} {G}_{j} ( x ) \} \qquad [ Equation 6 ]$$

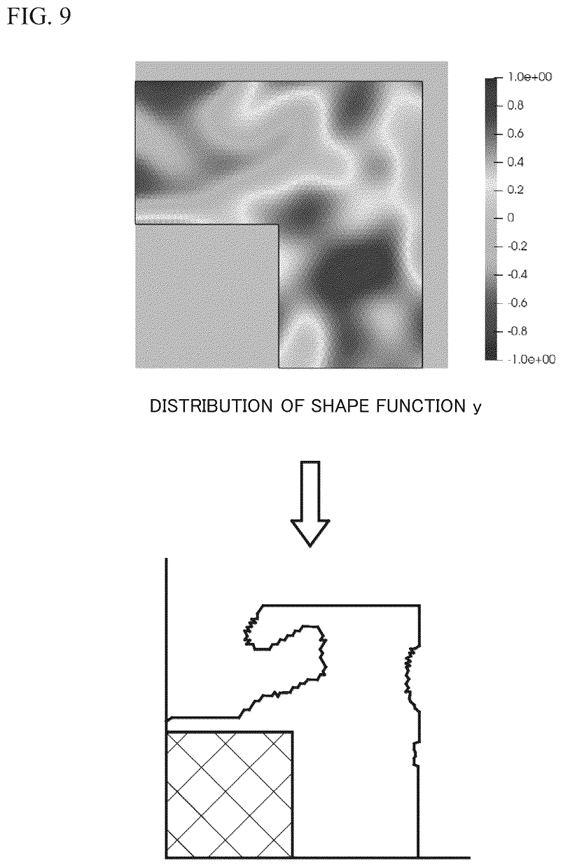

The distribution of the shape function y is illustrated in the upper diagram of FIG. 9. From this result, it becomes possible to determine material information from the magnitude of the shape function y, as illustrated in the lower diagram of FIG. 9. In the lower diagram of FIG. 9, if the shape function y is 0 or more, there is a substance, and if the shape function y is less than 0, there is no substance.

The purpose of magnetic shield shape optimization is to minimize the magnitude of the average magnetic flux density Bₐᵥₑ^{T} and the magnetic material area S_{mag} in the target area. Specifically, it involves minimizing the following equation. Note that E₁ is 1/10 of Bₐᵥₑ^{T} when the entire design domain is air. E₂ is S_{mag} when the entire design domain is magnetic.

$$E = \frac{α}{{E}_{1}} {B}_{ave}^{T} + \frac{β}{{E}_{2}} {S}_{mag} \to min . \qquad [ Equation 7 ]$$

This optimization problem was sampled using three methods: random sampling, FMDA only, and the method of this embodiment. The common settings were 96 initial points. α=0.5, β=0.5. In the FMDA only method, the number of iterations was 1536, and the number of DA setting recommendations was 1. In the method of this embodiment, the number of iterations was 384, the number of DA setting recommendations was 1, the number of GA setting recommendations was 3, the tournament size NT was 5, the crossover probability was 0.7, the mutation probability was 0.3, the threshold δ was 0.85, and the upper limit of the learning data was 400.

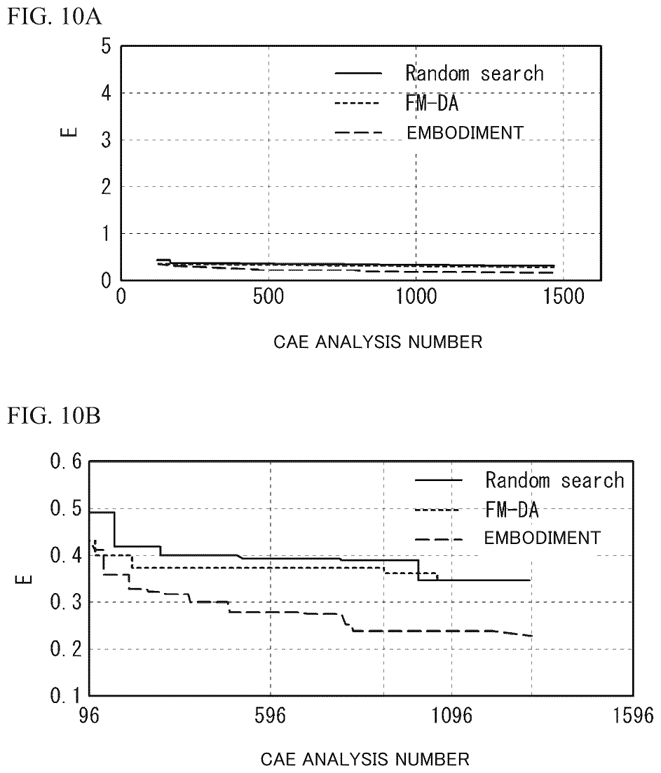

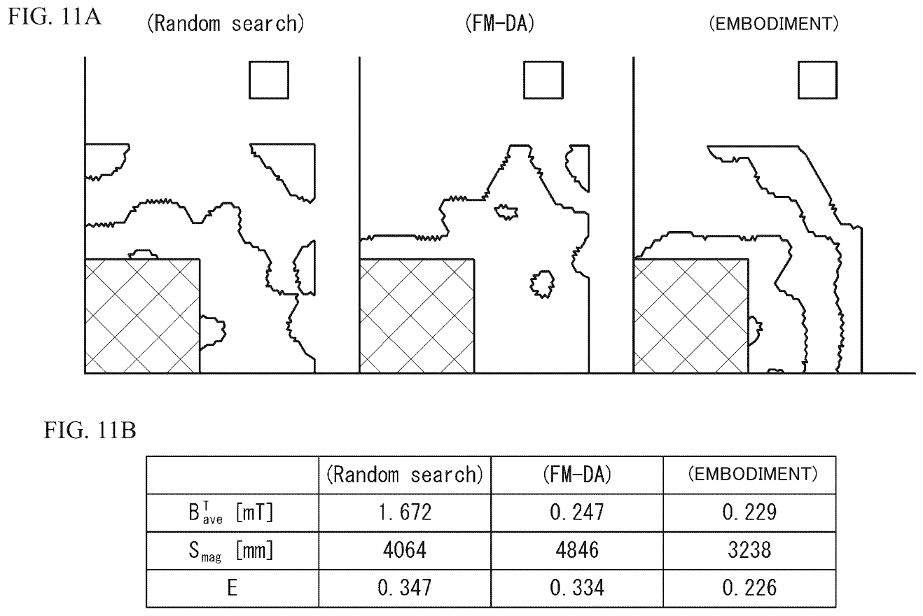

FIG. 10A, FIG. 10B, FIG. 11A, and FIG. 11B illustrate the results. FIG. 10A and FIG. 10B illustrate the best values found in the search. The vertical axis represents the energy E in the QUBO format. Therefore, the smaller the value on the vertical axis, the better the results. The number of CAE analyses on the horizontal axis indicates the number of iterations. FIG. 10B is an enlarged view of FIG. 10A with the vertical axis scaled. As illustrated in FIG. 10A, FIG. 10B, FIG. 11A, and FIG. 11B, the method of this embodiment can sample more efficiently than the random sampling method and the FMDA method.

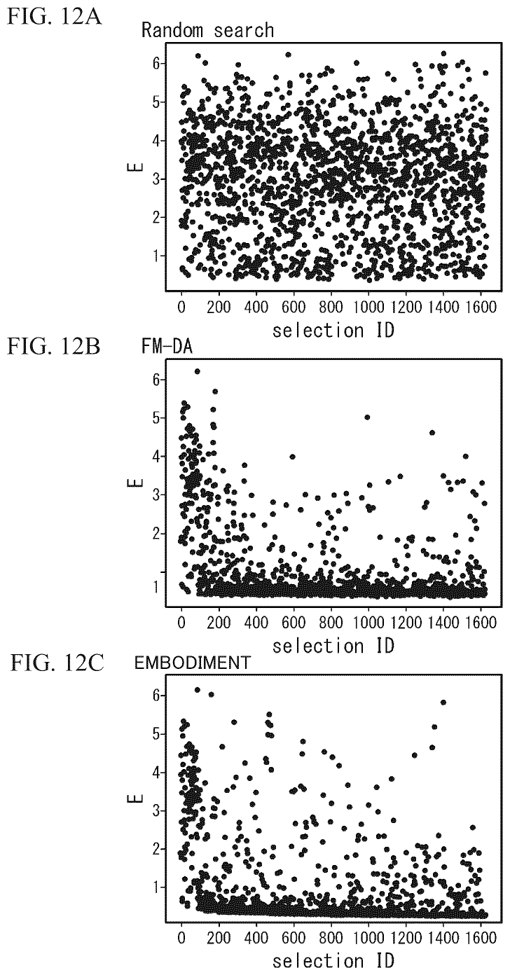

FIG. 12A to FIG. 12C are lists of the results obtained by the search using the random sampling method, the FMDA-only method, and the method of this embodiment, respectively. The vertical axis represents the energy E in the QUBO format. Therefore, the smaller the value on the vertical axis, the better the results. In the random sampling method, the distribution of the obtained solutions is scattered throughout. In the FMDA method and the method of this embodiment, the results obtained in the iterative processing part are concentrated in a small area of E. It can be seen that the method of this embodiment can search for an area with even smaller E than the FMDA method.

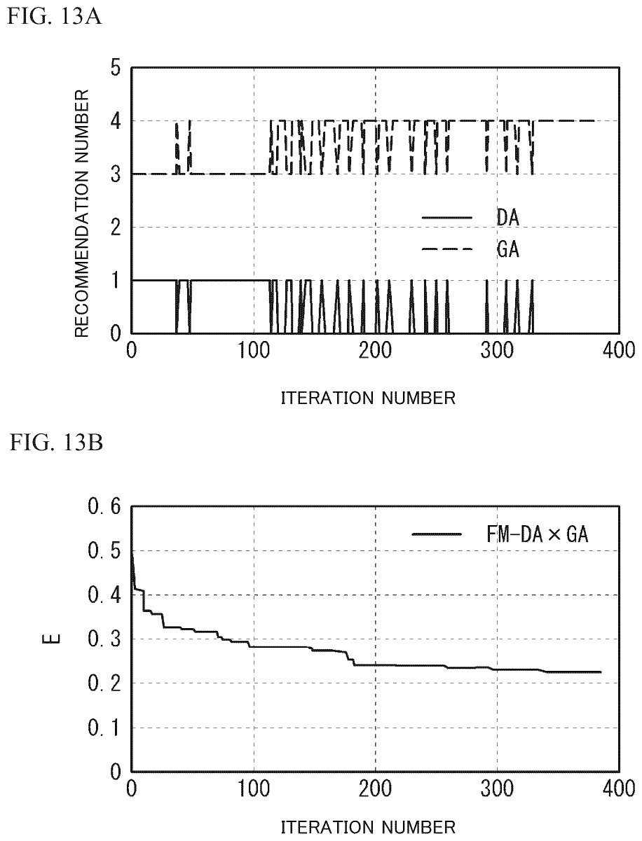

FIG. 13A illustrates the DA recommendation number and the GA recommendation number in each iteration. FIG. 13B illustrates a plot of the best value in each iteration. As illustrated in FIG. 12A and FIG. 12B, it can be seen that the FMDA recommendation works effectively in the early iteration, and the GA recommendation becomes dominant in the later iteration.

In the above example, the DA setting recommendation number is an example of the first setting number, the DA recommendation point is an example of the first recommendation point, the GA setting recommendation number is an example of the second setting number, and the GA recommendation point is an example of the second recommendation point. The GA executor 50 that executes steps S17 and S18 in FIG. 5 functions as an example of a determiner that determines the first setting number and the second setting number according to the accuracy of the model.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention. For example, the above-described coolant may be cold water or an antifreeze solution.

What is claimed is:

1. A non-transitory computer-readable recording medium that stores a program causing a computer to execute a process, the process including:
determining a first set number and a second set number according to accuracy of an Ising model, in repeating of a process of creating the Ising model based on a learning data group, searching for the first set number of a first recommendation point for the Ising model using an Ising machine, searching for the second set number of a second recommendation point for a learning data by a genetic algorithm, and adding the first recommendation point and a first evaluation value of the first recommendation point, and the second recommendation point and a second evaluation value of the second recommendation point, respectively, to the learning data group as a learning data.

2. The medium according to claim 1,
wherein the process further includes:
a process of not searching for the first recommendation point and increasing the second set number of the second recommendation point and searching for the second recommendation point, when the accuracy of the Ising model is less than a threshold.

3. The medium according to claim 1,
wherein the process further includes:
not searching for the first recommendation point, and setting a sum of the first set number and the second set number as the second set number to search for the second recommendation point, when the accuracy of the Ising model is less than a threshold.

4. The medium according to claim 1,
wherein the process further includes:
searching for the first recommendation point and the second recommendation point without changing the first set number and the second set number, when the accuracy of the Ising model is equal to or greater than a threshold.

5. The medium according to claim 1,
wherein an upper limit is set on a number of learning data in the learning data group, and
wherein the process further includes:
updating the learning data group according to an evaluation value of each of the learning data, when a number of the learning data in the learning data group exceeds the upper limit.

6. The medium according to claim 5,
wherein the process further includes:
leaving the upper limit number of the learning data in the learning data group in a descending order of evaluation value, and deleting other learning data, when the number of the learning data in the learning data group exceeds the upper limit.

7. A calculation method comprising:
determining a first set number and a second set number according to accuracy of an Ising model, in repeating of a process of creating the Ising model based on a learning data group, searching for the first set number of a first recommendation point for the Ising model using an Ising machine, searching for the second set number of a second recommendation point for a learning data by a genetic algorithm, and adding the first recommendation point and a first evaluation value of the first recommendation point, and the second recommendation point and a second evaluation value of the second recommendation point, respectively, to the learning data group as a learning data.

8. The calculation method according to claim 7, further comprising:
a process of not searching for the first recommendation point and increasing the second set number of the second recommendation point and searching for the second recommendation point, when the accuracy of the Ising model is less than a threshold.

9. The calculation method according to claim 7, further comprising:
not searching for the first recommendation point, and setting a sum of the first set number and the second set number as the second set number to search for the second recommendation point, when the accuracy of the Ising model is less than a threshold.

10. The calculation method according to claim 7, further comprising:
searching for the first recommendation point and the second recommendation point without changing the first set number and the second set number, when the accuracy of the Ising model is equal to or greater than a threshold.

11. The calculation method according to claim 7,
wherein in that an upper limit is set on a number of learning data in the learning data group, and
wherein the method further comprises:
updating the learning data group according to an evaluation value of each of the learning data, when a number of the learning data in the learning data group exceeds the upper limit.

12. The calculation method according to claim 11, further comprising:
leaving the upper limit number of the learning data in the learning data group in a descending order of evaluation value, and deleting other learning data, when the number of the learning data in the learning data group exceeds the upper limit.

13. An information processing device comprising:
a memory; and
a processor coupled to the memory and configured to:
determine a first set number and a second set number according to accuracy of an Ising model, in repeating of a process of creating the Ising model based on a learning data group, searching for the first set number of a first recommendation point for the Ising model using an Ising machine, searching for the second set number of a second recommendation point for a learning data by a genetic algorithm, and adding the first recommendation point and a first evaluation value of the first recommendation point, and the second recommendation point and a second evaluation value of the second recommendation point, respectively, to the learning data group as a learning data.

14. The information processing device according to claim 13,
wherein the processor is configured to not search for the first recommendation point and increases the second set number of the second recommendation point and searches for the second recommendation point, when the accuracy of the Ising model is less than a threshold.

15. The information processing device according to claim 13,
wherein the processor is configured to not search for the first recommendation point, and sets a sum of the first set number and the second set number as the second set number to search for the second recommendation point, when the accuracy of the Ising model is less than a threshold.

16. The information processing device according to claim 13,
wherein the processor is configured to search for the first recommendation point and the second recommendation point without changing the first set number and the second set number, when the accuracy of the Ising model is equal to or greater than a threshold.

17. The information processing device according to claim 13,
wherein an upper limit is set on a number of learning data in the learning data group, and
wherein the processor is configured to update the learning data group according to an evaluation value of each of the learning data, when a number of the learning data in the learning data group exceeds the upper limit.

18. The information processing device according to claim 17,
wherein the processor is configured to leave the upper limit number of the learning data in the learning data group in a descending order of evaluation value, and delete other learning data, when the number of the learning data in the learning data group exceeds the upper limit.
